(19) United States
(12) Patent Application Publication
(10) Pub. No.: US 2004/0004634 A1
(43) Pub. Date: Jan. 8, 2004

(54) System and method for remote training over a computer network

(75) Inventors: Miles Li, Chongqing City (CN); Owen Ou, Chongqing City (CN)

Correspondence Address: HOGAN & HARTSON L.L.P., 500 S. GRAND AVENUE, SUITE 1900, LOS ANGELES, CA, 90071-2611, US

(73) Assignee: FARSTONE TECH. INC.

(21) Appl. No.: 10/313,094

(22) Filed: Dec. 5, 2002

(30) Foreign Application Priority Data
Jul. 8, 2002 (TW) 091115099

(51) Int. Cl. G09G 5/00

(52) U.S. Cl. 345/733; 345/751

(57) ABSTRACT

A remote manipulating system and methodology that allows the user to easily operate specific functions. According to the invention, remote manipulating method is suitable for a host system coupled to a hand-operated apparatus. The method of the invention includes the step of outputting a signal from the hand-operated apparatus to the host system. The method also includes the steps of analyzing the signal to invoke at least one predetermined function upon receiving the signal and sending a predetermined message corresponding to the at least one predetermined function to a remote system over the computer network. The method further includes the steps of implementing the at least one predetermined function corresponding to the predetermined message for remote training, responsive to the remote system receiving the predetermined message issued from the host system. A system is also disclosed to carry out the method steps of the invention.

### BACKGROUND OF THE INVENTION

1. Field of the Invention

The present invention relates generally to a remote training technique over a computer network, and more particularly to a remote training system having a hand-operated apparatus that can be conveniently manipulated in order to operate specific functions easily.

2. Description of Prior Art

The field in network teaching and training, network broadcasting, network meeting, network remote maintaining and network monitoring, etc., User interfaces are all relatively complicated. Traditional mode, need to be familiar with complicated users interface at least at first. Moreover, to operate certain functions that define in advance, one has to move his/her mouse to click many times. Alternatively, one has to press several keys to initiate predefined function. After a series of movements, the function is executed. This would be an extremely complicated operation and time-consuming.

Referring to FIG. 1, a flowchart shows the conventional training software accomplishing its mission. As shown in FIG. 1, the mission is to execute the predefined function by pressing several keys or moving the mouse several times. First, at step S11, the user at the sever computer determines any, a group or all the client computers. Then, at step S12, the user clicks the client computers via the mouse or such several keys. Next, at step S13, the user selects several menus or buttons on the complicated user interface via the mouse or such several keys. Repeat step S13, then, at step S14, the user selects the predefined functions via the mouse or such several keys. Next, at step S15, the user executes the selected functions via the mouse or such several keys. Finally, at step S16, such selected functions are completed.

For example, the conventional training software, such as the FlexClass software developed by Flexsunland Corporation, includes a sever-side program executed at a sever computer. In addition, it further includes a client program executed at least one client computer. Prior to using the FlexClass software, the user must be relatively familiar with the basic operation of the computer, including how to move mouse, how to click, how to manipulate mouse, such as treatments of right click functions, range selecting, objects selecting, turn on window, close window, etc. a series of heavy and complicated movements the user have to know. Secondly, if you want to carry on the operation in the user interface of such software and carry out the function, the user need to be familiar with the function of every buttons on the interface, and is familiar with the operation of the software. Generally, this needs to understand and operate through training or study the help file of such software carefully.

Referring to FIG. 2, a flowchart shows the FlexClass software accomplishing its mission via the mouse or several keys. First, at step S21, the teacher user opens main window at the server computer. Then, at step S22, the teacher user selects any, a group or all the client computers to set the student users. Next, at step S23, the teacher user selects several menus or buttons on the complicated user interface for broadcasting to the client computers. Then, at step S24, the teacher user operates to execute the broadcast function. Next, at step S25, the sever-side program enters into a new interface. Then, at step S26, the teacher user can select predefined broadcasting functions from a Toolbar to execute application programs for broadcasting demonstration. Next, at step S27, the sever-side program executes predefined broadcasting functions. Then, at step S28, the sever-side program operates to transmit orders to the client computers over network. Finally, at step S29, such client computers receive order at client computer, and such selected predefined broadcasting functions are completed. Another conventional training software, such as the NetMeeting software developed by Microsoft Corporation, includes conferencing functions to communicate on the Internet. However, prior to using the NetMeeting software, the user must be relatively familiar with the basic operation of the computer, including how to move mouse, how to click, how to manipulate mouse, such as treatments of right click functions, range selecting, objects selecting, turn on window, close window, etc. a series of heavy and complicated movements the user have to know. Secondly, if you want to carry on the operation in the user interface of such software and carry out the function, the user need to be familiar with the function of every buttons on the interface, and is familiar with the operation of the software. Generally, this needs to understand and operate through training or study the help file of such software carefully.

FIG. 3 is a flow chart showing in detail the steps for transmitting a message by the NetMeeting software. The user starts NetMeeting via a mouse.

First, at step S31, the user moves the mouse to choose and initiate NetMeeting. Then, at step S32, the user moves the mouse and clicks call function of NetMeeting main interface. Next, at step S33, the user moves the mouse and clicks host meeting. Then, at step S34, the user may click the find someone in a directory button. The user moves the mouse and clicks “ok” option to confirm. Next, at step S35, in the select a directory field, the user selects microsoft internet directory. In the search window that appears, the user moves the mouse and clicks every “accept” option for requesting information. Then, at step S36, the user moves the mouse and clicks “chat” option. Next, at step S37, the user moves the mouse and keys in message to be delivered. Then, at step S38, the user moves the mouse and clicks “to everyone” option. Finally, at step S39, such user moves the mouse and clicks “send” option to deliver message.

The Videodidact product developed by Educational&Business Systems Corporation adopts a dedicated teaching keyboard. The Videodidact product is complicated in Network linking, in addition, the cost and the complexity of the equipment would rise with increase of the number of student machines. It is not suitable for a computer network, such as Internet and Intranet.

Referring to FIG. 4, a schematic block diagram of a Videodidact product is shown. The Videodidact product includes a teacher machine 11, certain hardware remote control equipments 12, a video equipment 13, a central controller 14, a keyboard and a mouse 15, a dedicated teaching keyboard 16 and several student machines 2.

As shown in FIG. 4, the hardware remote control equipments 12 are coupled to the teacher machine 11 and the video equipment 13. The keyboard and the mouse 15 are coupled to the hardware remote control equipments 12 to control the teacher machine 11 and the video equipment 13. The video equipment 13 is coupled to the teacher machine 11 and the central controller 14 to transmit video signals. The student machines 2 are coupled to the central controllers 14 and form a non-standard ether network. The dedicated teaching keyboard 16 is coupled to the central controllers 14, in order to remote control student machines, lock the keyboards and the mice of the student machines and carry on teaching functions. The conventional hardware teaching equipment even though has the dedicated teaching keyboard to facilitate teaching, nevertheless, the structure of such Videodidact product is complicated, the teacher machine adds other extra hardware equipments, and must send information through the central controller. The conventional hardware teaching equipment needs to install the complicated hardware equipment, even need to set up non-standard dedicated network. The user need to understand and operate through training or study the help file of such product carefully. Moreover, upgrading of the conventional hardware teaching equipment is relatively complicated, even need to change the hardware to reinstall directly.

### SUMMARY OF THE INVENTION

The present invention provides a remote training system and method to resolve the foregoing problems faced by the conventional teaching apparatus. The present invention also has the advantage of high performance. Remote training can be accomplished by only a single click. Moreover, the remote training system is suitable for a computer network environment.

An object of the present invention is to provide a remote training system and method, wherein a hand-operated apparatus is adopted for the users to manipulate conveniently.

In accordance with an aspect of the present invention, a remote training system is used in a computer network environment. The data protection system includes an input device, a host system and a remote system. The input device is used for generating and transmitting a signal. The host system is coupled to the input device for receiving the signal outputted from the input device, analyzing the received signal for invoking at least one predetermined function, and outputting a predetermined message. The remote system is used for receiving the predetermined message issued from the host system via the computer network, and for implementing the predetermined function corresponding to the predetermined message for remote training.

In the preferred embodiment of the invention, the remote system includes at least one computer. The input device can be a hand-operated apparatus. The hand-operated apparatus comprises at least one hotkey. The host system includes a data input device. The data input device can be a mouse or a keyboard.

In accordance with another aspect of the present invention, a host system is used for invoking at least one predetermined function. The host system comprises an input device, an analyzing device and a processing device. The input device is used for generating a signal. The analyzing device is coupled to the input device for analyzing the signal outputted from the input device. The processing device is coupled to the analyzing device for invoking the predetermined function.

In the preferred embodiment of the invention, the remote system includes an outputting device, which outputs a predetermined message to a remote system. The input device can be a hand-operated apparatus. The hand-operated apparatus comprises at least one hotkey. The host system includes a data input device. The data input device can be a mouse or a keyboard.

In accordance with a further aspect of the present invention, a remote training method is used in a computer network environment. The remote training method comprising the steps of: transmitting a signal from the input device; analyzing the received signal for invoking at least one predetermined function; outputting a predetermined message; and implementing the at least one predetermined function corresponding to the predetermined message for remote training.

In the preferred embodiment of the invention, the remote training method further comprises the step of operating the input device by an instructor. A host system receives the signal outputted from the input device. A remote system receives the predetermined message issued from the host system via the computer network. The host system executes a server program, and the remote system executes a client program. The remote system is remotely controllable by the host system.

The present invention may best be understood through the following description with reference to the accompanying drawings, in which:

### BRIEF DESCRIPTION OF THE DRAWING

FIG. 1 is a schematic flow chart of conventional training software.

FIG. 2 is a schematic flow chart of FlexClass software.

FIG. 3 is a schematic flow chart of NetMeeting software.

FIG. 4 is a schematic flow chart of a Videodidact product.

FIG. 5 is a schematic block diagram of a remote training system of a preferred embodiment according to the present invention.

FIG. 6 is a detailed schematic block diagram of a remote training system of a preferred embodiment according to the present invention.

FIG. 7 is a schematic flow chart of a remote training system of a preferred embodiment according to the present invention.

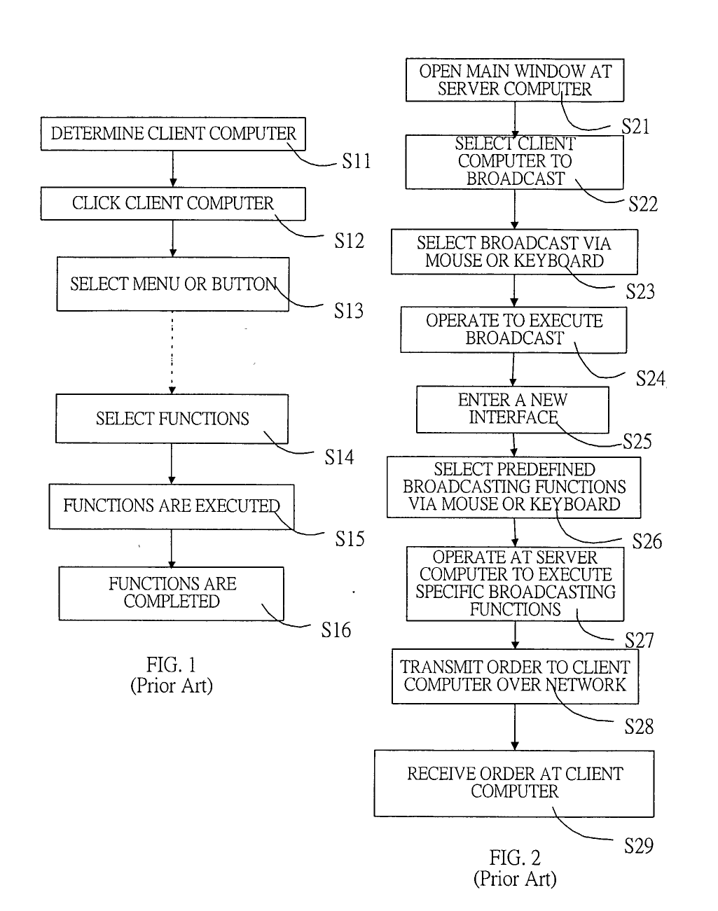

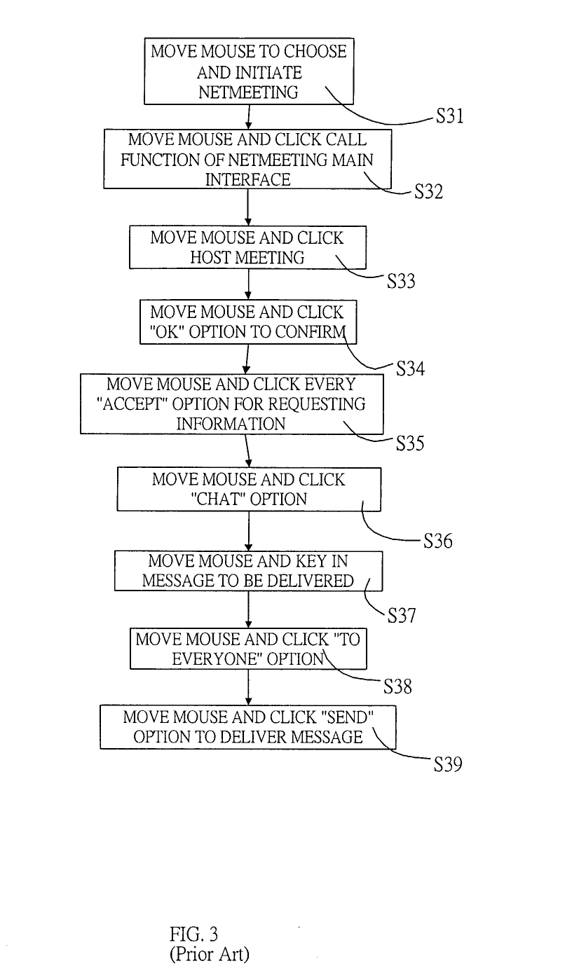

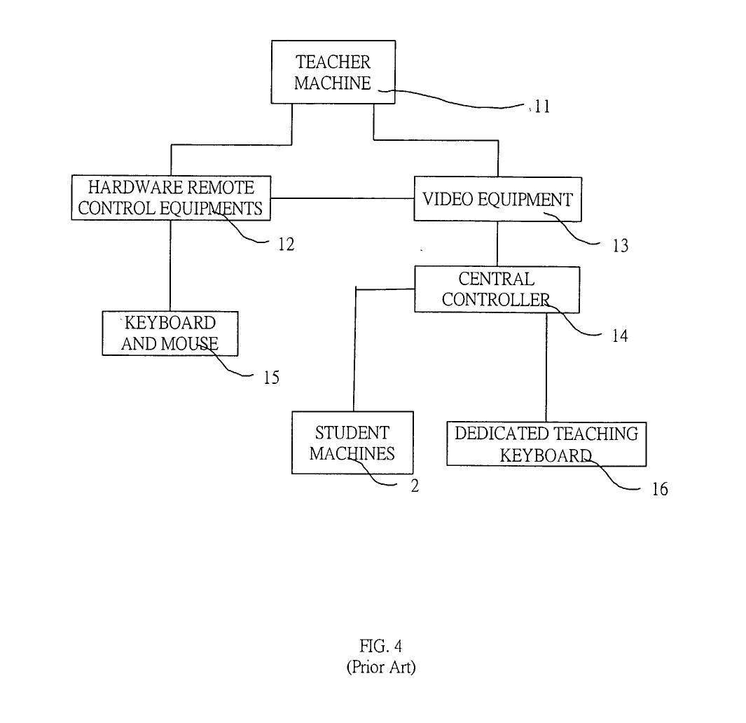

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a remote training system is used in a computer network environment. The data protection system includes an input device, a host system and a remote system. The input device is used for generating and transmitting a signal. The host system is coupled to the input device for receiving the signal outputted from the input device, analyzing the received signal for invoking at least one predetermined function, and outputting a predetermined message. The remote system is used for receiving the predetermined message issued from the host system via the computer network, and for implementing the predetermined function corresponding to the predetermined message for remote training.

According to the preferred embodiment of the present invention, the remote system includes at least one computer. The input device can be a hand-operated apparatus. The hand-operated apparatus comprises at least one hotkey. The host system includes a data input device. The data input device can be a mouse or a keyboard.

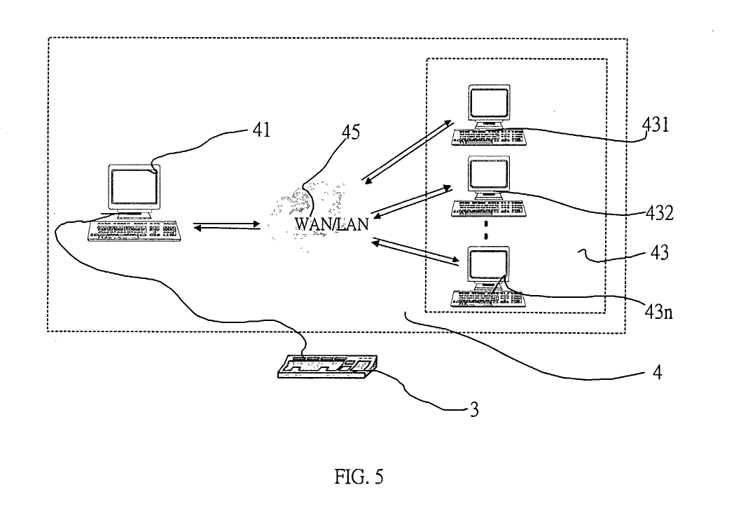

Referring to FIG. 5, a schematic block diagram of a remote training system of a preferred embodiment according to the present invention is shown. The remote training system of the present invention includes a hand-operated apparatus 3 and a processing apparatus 4 having a host system 41 and a remote system 43. The host system 41 includes at least a server computer. The client computers 431-434 contained in the remote system 43 connect the server computer through a computer network, such as Internet and Intranet.

The processing apparatus 4 obtains signal outputted from the hand-operated apparatus 3 and implements the predefined functions corresponding to the predefined message for remote training, responsive to the remote system 43 receiving the predefined message issued from the host system 41.

According to the preferred embodiment of the present invention, a host system is used for invoking at least one predetermined function. The host system comprises an input device, an analyzing device and a processing device. The input device is used for generating a signal. The analyzing device is coupled to the input device for analyzing the signal outputted from the input device. The processing device is coupled to the analyzing device for invoking the predetermined function.

The remote system further includes an outputting device, which outputs a predetermined message to a remote system. The input device can be a hand-operated apparatus. The hand-operated apparatus comprises at least one hotkey. The host system includes a data input device. The data input device can be a mouse or a keyboard.

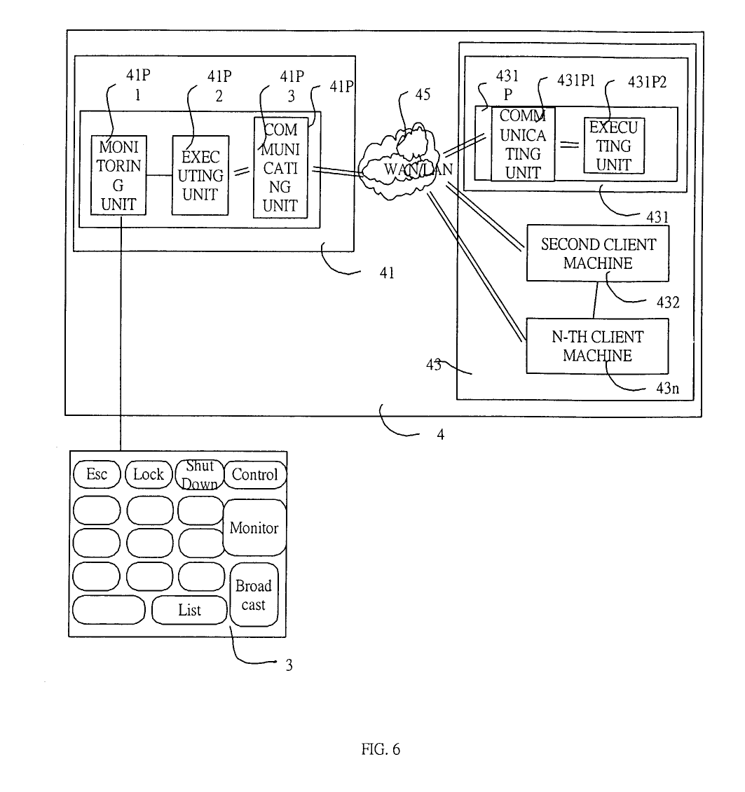

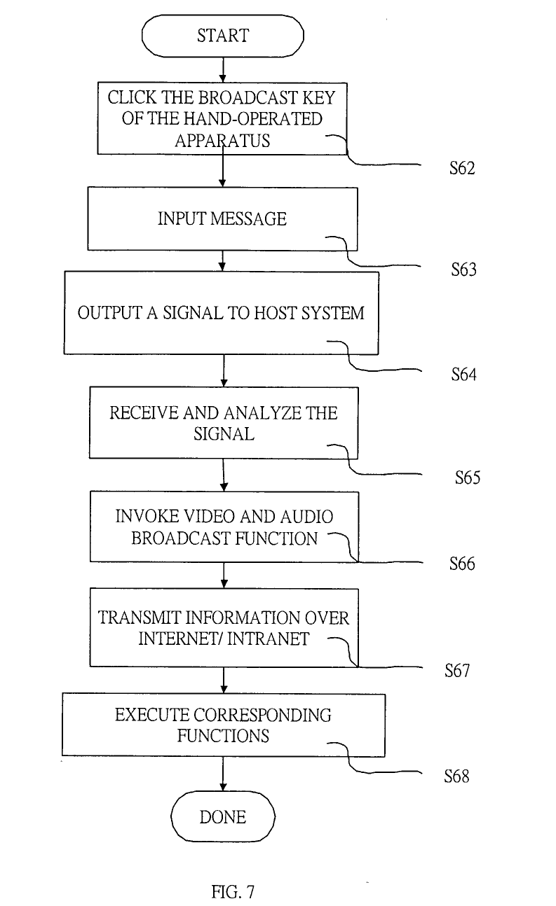

Referring to FIG. 6, a detailed schematic block diagram of a remote training system of a preferred embodiment according to the present invention is shown. The hand-operated apparatus 3 may be a USB keypad or a PS/2 keypad. Known as keypad or command-entry systems, they include a plurality of push-buttons, or a touch-sensitive pad, each pad corresponds to a specific function defined in advance under the executive mode.

According to one embodiment, a broadcast function, a monitor function, a control function, a shut down function, a lock function, and an escape function, are predefined. As shown in FIG. 6, the instructor at the hand-operated apparatus 3 can transfer the screen of the host system 41 to any, a group or all the client computers. In addition, the users at the remote system 43 can listen to the instructor's presentation. The instructor can view and scan through the screen of the remote system 43. The instructor can work with the users at the remote system 43 in a remote control mode, since the server computer 41 can remote control the client computers. The instructor can disable the keyboard and mouse of the remote system 43. The instructor can also lock the operating system (OS) of the remote system 43.

The server computer 41 runs a server program 41P, which comprises a monitoring unit 41P1, an executing unit 41P2 and a communicating unit 41P3. Each client computer runs a client program. For example, the client program 431P of the client computer 431 comprises an executing unit 431P2 and a communicating unit 431P1.

The monitoring unit 41P1 monitors the hand-operated apparatus 3 to receive the outputting signal issued from the hand-operated apparatus 3. The outputting signal is transmitted to the executing unit 41P2 to analyze. The executing unit 41P2 invokes at least one predefined function, such as video and audio broadcast function, and sends corresponding information to the communicating unit 41P3. The communicating unit 41 P3 transmits such information to the communicating units of the client computers over Internet/Intranet 45.

For example, the communicating units 431 P1 of the client computers 431 obtains such information and then sends to the executing unit 431 P2 of the client computers 431. The executing unit 431 P2 executes the corresponding functions according to the received information.

According to the preferred embodiment of the present invention, a remote training method is suitable for a computer network environment. The remote training method comprising the steps of: transmitting a signal from the input device; analyzing the received signal for invoking at least one predetermined function; outputting a predetermined message; and implementing the at least one predetermined function corresponding to the predetermined message for remote training.

The remote training method further comprises the step of operating the input device by an instructor. A host system receives the signal outputted from the input device. A remote system receives the predetermined message issued from the host system via the computer network. The host system executes a server program, and the remote system executes a client program. The remote system is remotely controllable by the host system.

Referring to FIG. 7, a schematic flow chart of a remote training method of the preferred embodiment according to the present invention is shown. According to the present invention, the remote training method of the present invention is suitable for broadcasting teaching. First, at step S62, the instructor at the hand-operated apparatus 3 clicks the broadcast key of the hand-operated apparatus. Then, at step S63, the instructor inputs message that is going to be broadcasted. Next, at step S64, the hand-operated apparatus 3 outputs a signal to the host system 41. Then, at step S65, the host system 41 receives and analyzes the signal. Next, at step S66, the host system 41 invokes at least one predefined function, such as video and audio broadcast function, upon receiving the signal. Then, at step S67, the host system 41 transmits information corresponding to such functions to a remote system over internet/intranet. Finally, at step S68, the remote system 43 executes the corresponding functions.

In the preferred embodiment of the invention, the operating systems adopted in the server computer 41 and the client computers 431 can be Windows 9x (Window 95, Window 98, Window Millennium, etc.), Linux, Windows NT, Window 2000, Window XP, Mac OS, or the like. The operating systems may be adopted differently within the computer system.

When the server computer 41 and the client computers 431 are booted respectively, the server program contained in the server computer 41 and the client programs contained in the client computers 431 are initiated. The host system 41 can remote controls the remote systems 43 directly without any call procedures.

The remote training system of the present invention can enable the host system 41 remote controlling the remote system 43 by only one click. In addition, the remote training system has all advantages of traditional training device, and makes the users more convenient, easier to learn and use without complicated operation and pre-training or reading the help files, that can effectively solved the conventional problems faced by the conventional remote training techniques.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A system for use in remote training over a computer network, said system comprising:
an input device for transmitting a signal;
a host system coupled to said input device for receiving said signal outputted from said input device, analyzing said received signal for invoking at least one predetermined function, and for outputting a predetermined message; and
a remote system for receiving said predetermined message issued from said host system via said computer network, and for implementing said at least one predetermined function corresponding to said predetermined message for remote training, wherein
said input device is operable to generate said signal.

2. The remote training system according to claim 1, wherein said input device is a hand-operated apparatus.

3. The remote training system according to claim 2, wherein said hand-operated apparatus comprises at least one hotkey.

4. The remote training system according to claim 1, wherein said host system includes a data input device.

5. The remote training system according to claim 4, wherein said data input device is a mouse.

6. The remote training system according to claim 4, wherein said data input device is a keyboard.

7. The remote training system according to claim 1, wherein said remote system includes at least one computer.

8. A host system for invoking at least one predetermined function comprising:
an input device for generating a signal;
an analyzing device coupled to said input device for analyzing said signal outputted from said input device; and
a processing device coupled to said analyzing device for invoking said at least one predetermined function.

9. The host system according to claim 8, wherein said input device is a hand-operated apparatus.

10. The host system according to claim 9, wherein said hand-operated apparatus comprises at least one hotkey.

11. The host system according to claim 8, wherein said host system includes a data input device.

12. The host system according to claim 11, wherein said data input device is a mouse.

13. The host system according to claim 11, wherein said data input device is a keyboard.

14. The host system according to claim 8, further comprising an outputting device, which outputs a predetermined message to a remote system.

15. A method for remote training using an input device over a computer network, said method comprising:
transmitting a signal from said input device;
analyzing said received signal for invoking at least one predetermined function;
outputting a predetermined message; and
implementing said at least one predetermined function corresponding to said predetermined message for remote training.

16. The remote training method according to claim 15, further comprising the step of operating said input device by an instructor.

17. The remote training method according to claim 15, further comprising the step of receiving said signal outputted from said input device by a host system.

18. The remote training method according to claim 17, further comprising the step of receiving said predetermined message issued from said host system via said computer network by a remote system.

19. The remote training method according to claim 18, wherein said host system executes a server program, and said remote system executes a client program.

20. The remote training method according to claim 18, wherein said remote system is remotely controllable by said host system.
